(19) United States
(12) Patent Application Publication
(10) Pub. No.: US 2012/0175149 A1
(43) Pub. Date: Jul. 12, 2012

(54) Functional Module and Method for Producing the Functional Module

(75) Inventors: Jan Ihle, Grambach (AT); Werner Kahr, Deutschlandsberg (AT); Volker Wischnat, Deutschlandsberg (AT); Steffen Mehlig, Berlin (DE)

(73) Assignee: EPCOS AG, Muenchen (DE)

(21) Appl. No.: 13/388,947

(22) PCT Filed: Jul. 30, 2010
(86) PCT No.: PCT/EP10/61139

§ 371 Date: Mar. 21, 2012

(30) Foreign Application Priority Data
Aug. 7, 2009 (DE) 10 2009 036 620.2

(51) Int. Cl. H01B 17/42; H01B 17/00

(52) U.S. Cl. 174/212; 156/423

(57) ABSTRACT

The invention relates to a functional module and a method for producing a functional module. The functional module includes an outer tube having a first and second end face and an inner surface. The functional module also includes an inner tube having a first and second end face and a lateral surface disposed within the outer tube. At least one molded part is disposed in a form-fitting manner between the inner surface of the outer tube and the shell surface of the inner tube. The functional module has a material with a positive temperature coefficient of electrical resistance. The first end face of the inner tube and the outer tube is disposed on an electrically isolative substrate and the molded part is thereby fixed between the outer tube and the inner tube by clamping force.

This patent application is a national phase filing under section 371 of PCT/EP2010/061139, filed Jul. 30, 2010, which claims the priority of German patent application 10 2009 036 620.2, filed Aug. 7, 2009, each of which is incorporated herein by reference in its entirety.

### TECHNICAL FIELD

The invention relates to a functional module and to a method for producing the functional module.

### BACKGROUND

Media or components can be heated by means of thermal contact with materials that have a positive temperature coefficient of electrical resistance (PTC materials). It has so far been possible for such PTC materials to be formed as sheets or rectangular elements. If the medium is not in direct contact with the PTC material but is in a container or enclosure, there may be reduced contact areas between the PTC materials and the enclosures if the enclosures or containers have curved surfaces. A small contact area between the PTC material and the enclosure results in a low efficiency on account of the unfavorable surface-volume ratio. For example, so far it has only been possible for round tubes through or around which fluids flow to be heated with low efficiency by means of PTC materials. This results in longer heating-up times and higher heating outputs.

Furthermore, PTC materials may be used in structural elements as overload protection. Here, too, it has so far not been possible to provide any elements with a curved surface.

### SUMMARY

In one embodiment, the present invention provides a functional module that has a high efficiency. Further embodiments of the functional module, a method for producing this functional module and use thereof are also disclosed herein.

### BRIEF DESCRIPTION OF THE DRAWINGS

The embodiments described are to be explained in even more detail on the basis of the figures and exemplary embodiments:

FIG. 1 shows a schematic side view of a cross section of the functional module;

FIG. 2 shows a schematic three-dimensional front view of the functional module and

FIG. 3 shows a schematic three-dimensional rear view of the functional module.

The following list of reference numbers can be used in conjunction with the drawings:

10 outer tube

15 contact element

20 molded object

30 inner tube

35 contact element

40 electrically insulating substrate

50 first end face

60 second end face

70 gap

### DETAILED DESCRIPTION OF ILLUSTRATIVE EMBODIMENTS

Embodiments of the present invention will be described first in text and then in further detail with regard to the figures.

One embodiment provides a functional module which comprises an outer tube having a first end face, a second end face and an inner surface, an inner tube having a first end face, a second end face and a lateral surface, which is arranged within the outer tube, and at least one molded object, which is arranged in a form-fitting manner between the inner surface of the outer tube and the lateral surface of the inner tube and comprises a material with a positive temperature coefficient of electrical resistance. In this case, the first end face of the outer tube and the first end face of the inner tube are arranged on an electrically insulating substrate and the molded object is fixed between the outer tube and the inner tube by clamping force.

This arrangement provides permanent contacting of the molded object by the outer tube and the inner tube and at the same time a frictional connection of the molded object between the outer tube and the inner tube without the use of adhesives or additional components. The molded object can consequently be bonded onto the outer tube and the inner tube with form-fitting engagement and over the full surface area, and consequently good thermal and/or electrical contacting can be made possible.

The electrically insulating substrate may comprise a material that has a high thermal stability.

For example, plastics may be chosen, and the plastics may also be filled with glass fibers. Examples of plastics are polyphenylene sulfide (PPS) or polytetrafluoroethylene (PTFE).

One effect of arranging the first end face of the inner tube and the first end face of the outer tube on the electrically insulating substrate is that of preventing a short circuit that could occur when a voltage is applied to the inner tube and the outer tube.

Furthermore, the inner tube and the outer tube can be connected with frictional engagement. The frictional connection allows the molded object to be pressed into the outer tube by means of the inner tube, and consequently a permanent electrical contact to be realized. The forces necessary for this can in this case be transferred by means of the electrically insulating substrate on which the inner tube and the outer tube are arranged. In this case, a compressive stress for pressing the inner tube into the molded object, and consequently for pressing the molded object into the outer tube, can be produced on the inner tube by the electrically insulating substrate. At the same time, a tensile stress equal in magnitude to the compressive stress is produced on the outer tube, since the outer tube is also mechanically connected to the electrically insulating substrate, for example, by means of angled-away brackets. The sum of all the forces occurring is consequently zero.

The frictional connection between the inner tube and the outer tube also allows good compensation for possibly occurring thermal expansions of the different materials of the outer tube, the inner tube and the molded object caused by changes in temperature, and consequently possibly accompanying mechanical damage.

The lateral surface of the inner tube comprises the wall of the inner tube, which has an inner surface, an outer surface and a wall thickness.

Furthermore, the inner tube may have a gap in the longitudinal direction of the inner tube. The gap in the lateral surface of the inner tube causes an interruption in the lateral surface along the entire inner tube.

The lateral surface of the inner tube and the inner surface of the outer tube may comprise a curvature, at least in partial regions. It is therefore possible to use cylindrical inner tubes, shaped with an oval cross section, and inner surfaces of outer tubes, or other, however formed, inner tubes and inner surfaces of outer tubes, which may be symmetrically or unsymmetrically shaped and the curvature of which may also be interrupted by a kink.

The molded object, which is arranged in a form-fitting manner between the lateral surface of the inner tube and the inner surface of the outer tube, similarly has the form of a tube. It is clamped in between the outer tube and the inner tube such that additional fixing, for example, by adhesive connections, is not necessary. There may also be a number of molded objects, for example, up to 10, arranged between the inner surface of the outer tube and the lateral surface of the inner tube. These are then arranged one behind the other, so that each molded object comprises an interface with respect to the lateral surface and the inner surface.

The inner surface of the outer tube and the lateral surface of the inner tube may in each case have a diameter. The diameter of the inner surface may in this case narrow from the first end face toward the second end face of the outer tube. Consequently, the diameter at the first end face of the outer tube is greater than at the second end face of the outer tube, the diameter of the inner surface of the outer tube steadily decreasing from the first end face to the second end face. Furthermore, the diameter of the lateral surface may narrow from the first end face of the inner tube to the second end face of the inner tube. Consequently, the diameter at the first end face of the inner tube is greater than the diameter at the second end face of the inner tube. The first end face of the inner tube lies on the same side as the first end face of the outer tube. Consequently, the progression of the narrowing of the inner tube is parallel to the narrowing of the inner surface of the outer tube. The inner tube and the inner surface of the outer tube consequently have, for example, a form which is shaped in the manner of a truncated cone.

This form of the inner surface of the outer tube allows the molded object, which is adapted to the inner surface of the outer tube in a form-fitting manner, to be pressed well into the outer tube, without it slipping through the outer tube. Similarly, the inner tube can be arranged well within the molded object, without it slipping through the molded object. Consequently, the fixing of the molded object between the outer tube and the inner tube is improved by clamping force. Furthermore, there can be good compensation for possibly occurring thermal expansions of the different materials of the outer tube, the inner tube and the molded object caused by changes in temperature, and consequently possibly accompanying mechanical damage.

The outer tube may also have an outer surface. This may be shaped according to the inner surface and have a diameter which is greater at the first end face of the outer tube than at the second end face of the outer tube. The outer surface of the outer tube may also be shaped such that the diameter of the outer surface at the first end face is as large as the diameter at the second end face of the outer tube, so that the inner surface of the outer tube is shaped in the manner of a truncated cone and the outer surface of the outer tube is cylindrically shaped.

The material of the outer tube and of the inner tube may be chosen from a group that comprises metals and metal alloys. For example, as a material, aluminum or copper or, as a metal alloy, brass may be chosen. These metals may serve as electrodes for the contacting of the molded object.

Furthermore, the inner tube may be resiliently shaped. This effect is made possible by the gap that is present in the lateral surface and can be further improved, for example, by using a spring steel. As a result, the molded object is pressed by the inner tube into the outer tube by increased clamping force, and consequently the fixing of the molded object between the outer tube and the inner tube is improved. The thermal and/or electrical contacting of the molded object through the outer tube and the inner tube is also improved as a result. The fixing and form-fitting contacting are in this case permanently stable, but not rigid, whereby possible mechanical damage, such as, for example, stress cracks, caused by different thermal expansions of the materials can be avoided. Consequently, instances of material fatigue can also be reduced.

The molded object, the outer tube and the inner tube may be in thermal contact with one another. Furthermore, a thermally conductive paste may be arranged between the lateral surface of the inner tube and the molded object and/or between the molded object and the inner surface of the outer tube. This ensures a good thermal contact between the molded object and the inner tube and/or between the molded object and the outer tube, so that the heat transfer between the inner tube and the molded object and between the outer tube and the molded object is optimized. The heat transfer is also improved by the adapted form of the molded object to the inner surface of the outer tube and to the lateral surface of the inner tube, since there is thermal contact over a large area between the molded object and the inner tube and the outer tube.

A material which comprises particles incorporated in polymers may be chosen for the thermally conductive paste. The particles may, for example, comprise thermally conductive metal particles, graphite particles or alumina particles. These particles provide good thermal conductivity of the paste arranged between the molded object and the inner tube and between the molded object and the outer tube.

Furthermore, the outer tube may have a first contact element and the inner tube may have a second contact element for producing an electrical current. In this case, the first contact element and the second contact element may protrude through the electrically insulating substrate, so that the contact elements can be externally contacted. The contact elements protrude through the substrate in such a way that they do not touch and are consequently insulated from one another. The contact elements may, for example, be shaped as metal sheets with connecting lugs, so that, for example, commercially available flat connectors or crimp connections may be connected to the contact elements. This allows a voltage to be applied to the molded object via the outer tube and the inner tube and the respective contact elements.

The narrowing of the inner surface of the outer tube and the lateral surface of the inner tube may have an angle in relation to an axis of rotation of the inner tube and in relation to an axis of rotation of the outer tube which is chosen from a range that comprises 1° to 10°. The angle may, for example, comprise between 1° and 5°. An axis of rotation should be understood here as meaning that it describes an imaginary line that is taken centrally through the inner tube or the outer tube respectively in the longitudinal direction of the inner tube or the outer tube. The point of intersection of this imaginary axis with a second imaginary line, which runs along the longitudinal direction of the inner tube on the lateral surface and beyond the second end face of the inner tube, or runs along the longitudinal direction of the outer tube on the inner side and beyond the second end face of the outer tube, gives the angle.

Furthermore, the molded object may have a thickness which is chosen from a range that comprises 0.3 mm to 3 mm. The thickness describes the wall thickness of the molded object.

The thickness of the molded object may be chosen in dependence on the applied voltage. Consequently, depending on the dimensions of the molded object, and thus depending on the distance of the inner tube from the outer tube, which represent the electrodes, the ohmic resistance in the molded object can be set.

The outer tube, the inner tube and the molded object may together lead to a diameter of the functional module which is chosen from a range that comprises 1 mm to 50 mm. The diameter of the functional module thereby comprises an inside diameter and an outside diameter. For example, the inside diameter may be 1 mm and give an outside diameter of 3.6 mm if the wall thickness of the inner tube is 0.3 mm, of the molded object is 0.5 mm and of the outer tube is 0.5 mm. Given the same wall thicknesses of the outer tube, the inner tube and the molded object, the outside diameter of the functional module may be 50 mm and the inside diameter 47.4 mm, for example.

The molded object of the functional module may contain a ceramic material which has the structure Ba_{1-x-y}MₓD_{y}Ti_{1-a-b}NₐMn_{b}O₃. The structure comprises a perovskite structure. In this structure, x comprises the range 0 to 0.5, y the range 0 to 0.01, a the range 0 to 0.01, b the range 0 to 0.01, M comprises a divalent cation, D a trivalent or tetravalent donor and N a pentavalent or hexavalent cation. M may be, for example, calcium, strontium or lead, D may be, for example, yttrium or lanthanum; examples for N are niobium or antimony. The molded object may comprise metallic impurities which are present with a content of less than 10 ppm. The content of metallic impurities is so small that the PTC properties of the molded object are not influenced.

This material may have a Curie temperature which comprises a range from −30° C. to 340° C. The material of the molded object may also have a resistance at 25° C. which lies in a range from 3 Ωcm to 30 000 Ωcm.

A method for producing a functional module with the aforementioned properties is also provided. The method comprises the method steps of:

A) providing an outer tube having a first end face and an inner surface and an inner tube having a first end face and a lateral surface,

B) injection-molding or compression-molding at least one molded object, which has a form which is adapted to the inner surface of the outer tube and to the lateral surface of the inner tube,

C) sintering the molded object,

D) arranging the molded object in the outer tube,

E) arranging the inner tube in the molded object, and

F) arranging the first end face of the inner tube and of the outer tube on an electrically insulating substrate, the inner tube pressing the molded object against the inner surface of the outer tube.

In this method, in method step B) the molded object is adapted to the inner surface of the outer tube with allowance for the shrinkage of the molded object. Depending on the composition of the material for the molded object, a shrinkage of the volume of the molded object may occur during the sintering in method step C). Consequently, in method step B) a molded object which, before sintering, has a form that is too large for the inner surface of the outer tube and the lateral surface of the inner tube to which the molded object is adapted and, after sintering, is adapted to the inner surface and the lateral surface is injection-molded or compression-molded.

This ensures a large thermal and electrical contact area between the molded object and the inner tube and between the molded object and the inner surface of the outer tube.

Furthermore, in method step B) a ceramic starting material which comprises a ceramic filling material of the structure Ba_{1-x-y}MₓD_{y}Ti_{1-a-b}NₐMn_{b}O₃ and a matrix is provided for the production of the molded object.

In order to produce the ceramic starting material with less than 10 ppm of metallic impurities, it may be produced with tools which have a hard coating, in order to avoid abrasion. A hard coating may, for example, consist of tungsten carbide. All the surfaces of the tools that come into contact with the ceramic material may be coated with the hard coating.

In this way, a ceramic filling material which can be transformed into a ceramic PTC material by sintering may be mixed with a matrix and processed into granules. For further processing into the molded object, these granules may be injection-molded or compression-molded.

The matrix in which the ceramic filling material is incorporated and which has a lower melting point than the ceramic material may in this case comprise a proportion of less than 20% by mass with respect to the ceramic material. The matrix may comprise a material which is chosen from a group that comprises wax, resins, thermoplastics and water-soluble polymers. Further additives, such as antioxidants or plasticizers, may likewise be present.

Method step B) may comprise the steps of:

B1) providing the ceramic starting material,

B2) injection-molding or compression-molding the starting material into a form, and

B3) removing the matrix.

During the sintering in method step C), the ceramic starting material is transformed into the material of the molded object which has a positive temperature coefficient of electrical resistance.

In method steps D) and E), the molded object is fixed between the inner surface of the outer tube and the lateral surface of the inner tube by clamping force.

By arranging the inner tube and the outer tube on the electrically insulating substrate in method step F), a frictional connection is produced between the inner tube and the outer tube.

The use of the functional module as a heating module in a heating system or as an overload protection module in a switching system is also provided.

This provides a heating module which can be used, for example, as a through-flow heater or as a connecting element in a heating system which efficiently heats a medium that is made to pass through the inner tube and/or around the outer tube. By applying a voltage to the molded object, the latter heats up on account of its positive temperature coefficient of electrical resistance, and this heat can be given off to the inner tube and the outer tube. In this case, the molded object has a self-regulating behavior. If the temperature in the molded object reaches a critical value, the resistance in the molded object also increases, so that less current flows through the molded object. This prevents further heating up of the molded object, as a result of which no additional electronic control of the heating output has to be provided. With this heating module, the medium that is made to pass through the inner tube and/or around the outer tube can be heated indirectly through the molded object. The heating module may similarly be used for heating components arranged in the inner tube and/or outside the outer tube.

The use of a molded object arranged in a form-fitting manner against the inner surface of the outer tube and against the lateral surface of the inner tube makes it possible to improve the efficiency of the heating module in comparison with conventional heating modules, since thermal and electrical contacting over a large area is provided between the molded object and the inner tube and between the molded object and the outer tube, and there is consequently a favorable surface-volume ratio.

Furthermore, there is no direct contact between the medium to be heated that is made to pass through the inner tube and/or around the outer tube, or the component arranged in the inner tube and/or outside the outer tube, and the molded object. This makes it possible to avoid the molded object being corrosively attacked by a medium to be heated or dissolved by the medium, and/or avoid the material of the molded object contaminating the medium to be heated or the component to be heated.

For heating components arranged outside the outer tube, the contact area between the lateral surface of the inner tube and the molded object may be smaller than the contact area between the molded object and the inner surface of the outer tube. Furthermore, the thickness of the inner tube may be less than the thickness of the outer tube. This has the effect of forming a strongly outwardly directed heat sink, which brings about a high degree of heat dissipation through the outer tube, while less heat is dissipated through the inner tube. Such a heating module may be used, for example, as a heating cartridge.

An overload protection module in switching systems in which high currents flow may also be provided. The shaping described above of the inner tube, the molded object and the outer tube achieves the effect of a large cross section of the molded object, which leads to low resistances for a small voltage drop across the molded object. At the same time, a small and space-saving type of construction of the module is realized. This allows a large number of electronic circuits comprising high current consumers for which overload protection is required to be equipped with a reversible, self-regulating overload protection module that includes a PTC molded object, even when only a small installation space is available.

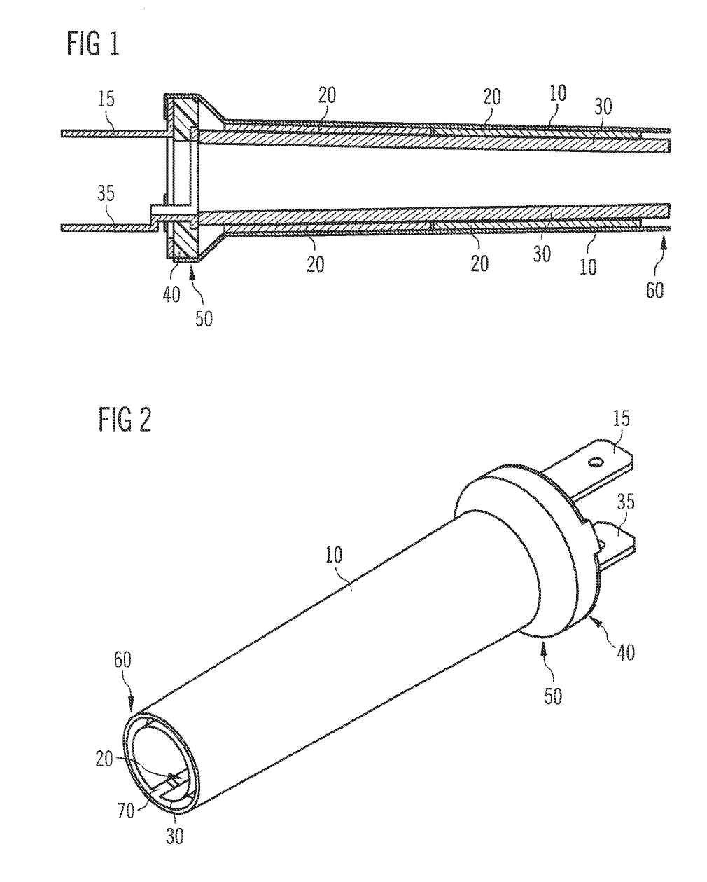

FIG. 1 shows a schematic side view of a cross section of the functional module. Arranged between the outer tube 10 and the inner tube 30 is at least one molded object 20. In FIG. 1, two molded objects 20 arranged one behind the other are shown by way of example, but it is also possible for only one molded object 20 or more than two molded objects one behind the other to be arranged between the inner tube 30 and the outer tube 10.

The molded object 20 comprises a ceramic with a positive temperature coefficient of electrical resistance and contains a material with the structure Ba_{1-x-y}MₓD_{y}Ti_{1-a-b}NₐMn_{b}O₃.

The outer tube 10 is connected in an electrically conducting manner to a contact element 15 and the inner tube 30 is connected in an electrically conducting manner to a contact element 35. The contact elements 15 and 35 protrude separately from each other through an electrically insulating substrate 40, so that they can be connected externally to a power source and at the same time a short circuit between the inner tube 30 and the outer tube 10 can be avoided. The outer tube 10 and the inner tube 30 are in this case shaped from metals or metal alloys and serve as electrodes for the molded object 20.

The functional module may be shaped, for example, as a heating module. Then, a medium which is indirectly heated by the PTC effect of the molded object 20 when a voltage is applied is made to pass inside the inner tube 30 and/or outside the outer tube 10. The functional module may also be used for enclosing a component, for example a connector, that is intended to be heated. The heating operation begins as soon as a current flow is produced in the molded object 20 by the electrical contacting via the contact elements 15 and 35.

The inner tube 30 and the outer tube 10 each have a first end face 50 and a second end face 60. For the sake of overall clarity, the first end faces of the inner tube and of the outer tube, lying on the same side of the functional module, are identified by one and the same designation in FIGS. 1 to 3. The second end faces are handled similarly.

The inner tube has a lateral surface which is shaped such that the diameter of the inner tube is greater at the first end face 50 than at the second end face 60. Equally, the diameter at the first end face 50 of the inner surface of the outer tube is made greater than the diameter at the second end face of the inner surface. Furthermore, in the lateral surface of the inner tube 30 there is a gap 70 (not shown here), and the inner tube 30 is resiliently shaped. Furthermore, a frictional connection between the inner tube 30 and the outer tube 10 is produced by the electrically insulating substrate 40. This allows the molded object 20 to be pressed into the outer tube 10 by the inner tube 30. This produces permanent, non-rigid contacting of a clamping nature, which does not require any adhesive connections or additional components, so that possible expansions of the different materials can be compensated, without mechanical stresses occurring in the functional module.

FIG. 2 shows a schematic three-dimensional front view of the functional module. Here, the gap 70 in the lateral surface of the inner tube 30 can be seen, the gap resulting in the clamping force of the inner tube 30. Also shown are the contact elements 15 and 35, which are shaped by way of example as metal sheets with connecting lugs.

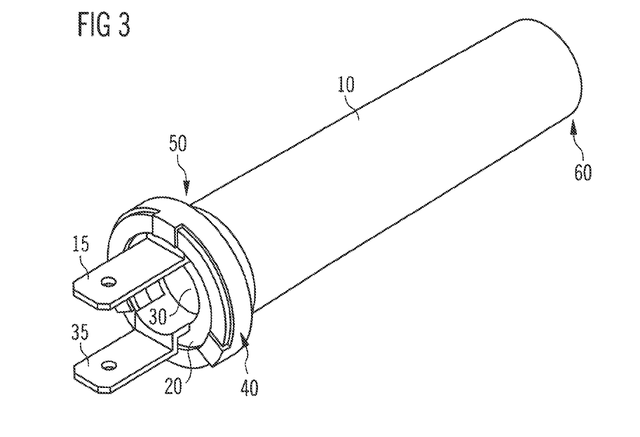

In FIG. 3, the rear view analogous to FIG. 2 of the functional module is shown in a three-dimensional schematic view. In the foreground here are the contact elements 15 and 35, which can be connected by commercially available flat connectors or crimp connections. The molded objects 20 located in the outer tube 10 cannot be seen. At the first end face 50, part of the inner tube 30 can be seen inside the functional module.

The embodiments shown in the figures may be varied as desired. It should also be taken into consideration that the invention is not restricted to the examples but allows further refinements that are not presented here.

1. A functional module, comprising:
an outer tube having a first end face, a second end face and an inner surface;
an inner tube having a first end face, a second end face and a lateral surface arranged within the outer tube;
a molded object arranged in a form-fitting manner between the inner surface of the outer tube and the lateral surface of the inner tube, the molded object comprising a material with a positive temperature coefficient of electrical resistance; and
an electrically insulating substrate, wherein the first end face of the outer tube and the first end face of the inner tube are arranged on the electrically insulating substrate and the molded object is fixed between the outer tube and the inner tube by clamping force.

2. The functional module according to claim 1, wherein the inner tube has a gap in a longitudinal direction of the inner tube.

3. The functional module according to claim 1, wherein the inner surface of the outer tube has a diameter that narrows from the first end face toward the second end face.

4. The functional module according to claim 3, wherein the lateral surface of the inner tube has a diameter that narrows from the first end face toward the second end face.

5. The functional module according to claim 1, wherein the outer tube comprises a metal or metal alloy and the inner tube comprises a metal or metal alloy.

6. The functional module according to claim 1, wherein the inner tube is resiliently shaped.

7. The functional module according to claim 1, wherein the inner tube and the outer tube are frictionally connected.

8. The functional module according to claim 1, wherein the outer tube has a first contact element and the inner tube has a second contact element, the first contact element and the second contact element protruding through the insulating substrate.

9. The functional module according to claim 4, wherein the inner surface and the lateral surface have an angle in relation to a central axis of the inner tube and a central axis of the outer tube, the angle being in a range from 1° to 10°.

10. The functional module according to claim 1, wherein the molded object has a thickness in a range from 0.3 to 3 mm.

11. The functional module according to claim 1, wherein the molded object contains a ceramic material having a structure Ba_{1-x-y}MₓD_{y}Ti_{1-a-b}NₐMn_{b}O₃, where x comprises the range 0 to 0.5, y the range 0 to 0.01, a the range 0 to 0.01, b the range 0 to 0.01, M comprises a divalent cation, D a trivalent or tetravalent donor and N a pentavalent or hexavalent cation.

12. The functional module according to claim 1, wherein the molded object has a Curie temperature with a range from −30° C. to 340° C.

13. The functional module according to claim 1, wherein the molded object has a resistance at 25° C. in a range from 3 Ωcm to 30 000 Ωcm.

14. (canceled)

15. The functional module according to claim 1, wherein the functional module comprises a heating module in a heating system.

16. The functional module according to claim 1, wherein the functional module comprises an overload protection module in a switching system.

17. The functional module according to claim 1, wherein the lateral surface of the inner tube has a diameter that narrows from the first end face toward the second end face.

18. A method of making a functional module, the method comprising:
providing an outer tube having a first end face, a second end face and an inner surface, and an inner tube having a first end face, a second end face and a lateral surface;
arranging the inner tube within the outer tube;
forming a molded object in a form-fitting manner between the inner surface of the outer tube and the lateral surface of the inner tube, the molded object comprising a material with a positive temperature coefficient of electrical resistance; and
fixing the molded object between the outer tube and the inner tube by a clamping force, wherein the first end face of the outer tube and the first end face of the inner tube are arranged on an electrically insulating substrate.

19. The method according to claim 18, wherein forming the molded object comprises:
injection-molding or compression-molding the molded object in a form that is adapted to the inner surface of the outer tube and to the lateral surface of the inner tube;
sintering the molded object;
arranging the molded object in the outer tube; and
arranging the inner tube in the molded object.

20. A method of making a functional module, the method comprising:
providing an outer tube having a first end face and an inner surface and an inner tube having a first end face and a lateral surface;
injection-molding or compression-molding a molded object to a form that is adapted to the inner surface of the outer tube and to the lateral surface of the inner tube;
sintering the molded object;
arranging the molded object in the outer tube;
arranging the inner tube in the molded object; and
arranging the first end face of the inner tube and of the outer tube on an electrically insulating substrate, wherein the inner tube presses the molded object against the inner surface of the outer tube.
